(19) United States
(12) Patent Application Publication
(10) Pub. No.: US 2012/0080543 A1
(43) Pub. Date: Apr. 5, 2012

(54) Device for Humidifying a Bulk Commodity

(75) Inventors: Mario Dikty, Apensen (DE); Dominik Deimel, Stade (DE); Carsten Greiser, Hamburg (DE)

(73) Assignee: CLAUDIUS PETERS TECHNOLOGIES GMBH, Buxtehude (DE)

(21) Appl. No.: 13/376,466

(22) PCT Filed: Jan. 19, 2010
(86) PCT No.: PCT/EP2010/000281

§ 371 Date: Dec. 6, 2011

(30) Foreign Application Priority Data
Jun. 8, 2009 (DE) 20 2009 007 971.6

(51) Int. Cl. B05B 1/14

(52) U.S. Cl. 239/556

(57) ABSTRACT

A device for humidifying a bulk material, particularly for humidifying power plant filter ash, comprises a downpipe. At the upper end of the downpipe, there is formed an inlet, through which the bulk material enters the downpipe, and at the lower end of which there is formed an outlet, through which the bulk material leaves in a humidified state. A plurality of water nozzles are arranged on a first plane in the downpipe and a plurality of water nozzles are arranged on a second plane in the downpipe. The water nozzles of the first plane are arranged offset at an angle to the water nozzles of the second plane. With the device and a corresponding method, the bulk material can be humidified effectively and deposits of the bulk material can be removed from the downpipe.

### BACKGROUND

The invention relates to a device for humidifying a bulk material, particularly for humidifying power plant filter ash. The device comprises a downpipe with an inlet at the upper end, through which the bulk material enters the downpipe, and an outlet at the lower end, through which the humidified bulk material leaves.

There are bulk materials which in the dry state tend to form dust. These include, for example, ash, as occurs during the operation of a power plant. If it is intended to dispose of the bulk material from the power plant, the surroundings may be affected considerably by the dust that is created. It is known that dust formation in the case of these bulk materials can be reduced by humidification, see for example DE4127447 and DE19742334. However, it is found that it is not very easy to humidify the bulk material uniformly. Moreover, the humidified bulk material has a tendency to become deposited on the wall of the mixer. In the prior art, complex measures are provided to ensure uniform humidification of the bulk material and keep the downpipe free from deposits of the bulk material. Thus, for example, in DE4127447, the bulk material is set in rotational motion before it comes into contact with a curtain of water, and a rotor element is provided to strip the bulk material from the walls of the downpipe. In DE 19742334, a part surrounding the downpipe is displaceable in relation to the downpipe, so that the size of an annular gap can be varied. Both are susceptible to errors and require regular maintenance.

### SUMMARY

A device and a method is provided for humidifying bulk materials which, with a simple structure, reliably humidify the bulk material and in which the downpipe is kept free from deposits of the bulk material. The device comprises a plurality of water nozzles which are arranged on a first plane and a plurality of water nozzles which are arranged on a second plane. The water nozzles of the first plane are arranged offset at an angle to the water nozzles of the second plane. A water nozzle on a first plane is set at an angle to a water nozzle on a second plane if the radii taken from the water nozzles to the axis of the downpipe are not parallel to one another.

The device is suitable for bulk materials of various types. There are bulk materials with which it is difficult to achieve complete and uniform humidification. In the case of such bulk materials, it is advisable to use the water nozzles of both planes for humidifying the bulk material. Considering first the nozzles of one plane, the water emerging from the water nozzles penetrates into the bulk material and at the same time has the effect that the bulk material is intermixed transversely in relation to its direction of movement. The intermixing is particularly effective because the water does not impinge on the bulk material in an evenly distributed manner over the circumference of the downpipe, but only from the direction of the water nozzles. In this way, the bulk material in the center of the stream of bulk material is also reliably humidified. However, complete humidification of the stream of bulk material is still not achieved by the water nozzles arranged on this plane, because between every two adjacent water nozzles there is a gap in which no water impinges on the stream of bulk material. These gaps are covered by the water nozzles of the second plane that are arranged offset at an angle, so that the water nozzles of the two planes have the overall effect that the stream of bulk material is humidified completely.

There are other bulk materials which can be humidified more easily and with which it is sufficient for complete humidification if the water impinges on the stream of bulk material only from the water nozzles of one plane (humidifying plane). On the other hand, these bulk materials often have a strong tendency to become lodged on the walls of the downpipe, for example in the region of the humidifying plane. If, following an interruption in the stream of bulk material, water is discharged from the water nozzles of the other plane, which is referred to hereafter as the cleaning plane, this water can dislodge the deposits. Tests have shown that the cleaning is particularly effective if the water impinges on the deposits at an acute angle. The water nozzles of the cleaning plane are preferably designed such that the water emerges at a corresponding angle. The arrangement of the water nozzles of the cleaning plane offset at an angle to the water nozzles of the humidifying plane means that particularly deposits which have settled between the water nozzles of the humidifying plane are removed effectively.

The device can therefore be used with advantage for bulk materials of various types. In the case of bulk materials which can only be humidified with difficulty, effective humidification is achieved by water from the water nozzles of a number of planes. In the case of bulk materials which can be humidified easily, but which have a tendency to form deposits, the water nozzles of one plane are sufficient for the humidification. With the water nozzles of the other plane, the deposits are removed. To be able to use the water nozzles of the humidifying plane and the cleaning plane separately in this way, it is preferably possible to feed water to the different planes independently from one another.

The term water in connection with the humidification of the bulk material is representative of all liquids that reduce the development of dust when they are fed to the bulk material. This comprises fresh water, waste water and contaminated water. Liquids in which the main constituent is something other than water are also included. The water may contain solids, for example suspended solids.

It is found that the bulk material is deposited particularly in the regions of the downpipe in which the wall of the downpipe has projections and in which elements protrude into the interior of the downpipe. To offer less in the way of points of attachment for the bulk material, the inner wall of the downpipe is preferably smooth. The water nozzles with their fastening means may be designed such that they do not project from the wall, that is to say do not protrude into the downpipe. If the downpipe is made up of a number of parts, the parts may finish flush with one another at the joints. Furthermore, the inner wall of the downpipe may be provided with an adhesion-preventing coating, which counteracts adhesive attachment of the bulk material. For example, the inner wall of the downpipe may be enameled. It may be sufficient if the adhesion-preventing coating is applied in the region in which the deposits of the bulk material are to be expected. This is the region below and slightly above the water nozzles from which the bulk material is humidified.

The risk of deposits also exists below the region in which the humidification takes place. Preferably, the lowermost plane of water nozzles is arranged close to the lower end of the downpipe, so that the bulk material no longer has any possibility of becoming deposited on the wall of the downpipe. The distance between the lowermost plane of water nozzles and the lower end of the downpipe is preferably less than 50 cm, more preferably less than 20 cm, more preferably less than 10 cm. Since the stream of bulk material is not yet intermixed sufficiently with the water so soon after the lowermost plane of water nozzles, the lower end of the downpipe is preferably adjoined by a tube with a flexible wall. The tube preferably has substantially the same diameter and the same alignment as the downpipe, so that the stream of bulk material can continue on its way unhindered. The flexible wall of the tube moves under the influence of the stream of bulk material. As a result, the intermixing of the stream of bulk material with the water is improved and the bulk material is prevented from being deposited on the wall of the tube. The tube may, for example, be composed of rubber. To give the tube sufficient stability, wire inserts may be provided, possibly extending for example spirally through the rubber material.

In the case of one embodiment, the water nozzles of one or more planes are arranged in the wall of the tube. The tube then forms part of the downpipe in which the wall is not rigid but flexible. Deposits are then also prevented in the region of the water nozzles by the movement in the wall of the tube.

The device may be set up in such a way that, from the outset, the water nozzles of a cleaning plane are not intended to humidify the bulk material, but are specifically designed for cleaning the inner wall of the downpipe. Such a cleaning plane may be arranged above or below a humidifying plane. Preferably, the cleaning plane is arranged where deposits of the bulk material are not to be expected. It is then not detrimental if the water nozzles of the cleaning plane protrude into the interior space of the downpipe, and it is easier to design the water nozzles such that the water impinges on the deposits at a favorable angle.

Water nozzles in the case of which the water jet is deflected by a diverting area protruding into the interior space of the downpipe may be used on the cleaning plane. Preferably, the water is deflected such that it impinges on the wall of the downpipe at an acute angle. To be able to remove the deposits over the surface area, the water jet preferably has the form of a flat jet. The acute angle is preferably less than 45°, more preferably less than 30°.

It is also advantageous for the water nozzles of the cleaning plane if they are offset at an angle to the nozzles of the humidifying plane. This is so because it is particularly the region between the nozzles of the humidifying plane that needs cleaning. However, the angular offset is not absolutely necessary. In an independently inventive embodiment, one plane is formed as a humidifying plane and one plane is formed as a cleaning plane, without the water nozzles of the planes being offset at an angle to one another. The water nozzles of the cleaning plane protrude into the downpipe, the water nozzles of the humidifying plane do not protrude into the downpipe. This embodiment may be combined with the other features.

It is a prerequisite for effective humidification of the stream of bulk material that the water penetrates into the stream of bulk material. It is conducive to this if the water nozzles in one plane lie opposite one another in pairs. This feature preferably applies to all the water nozzles of one plane, more preferably to all the water nozzles of the device. The water acting from two opposite directions has the effect of ensuring that the water penetrates into the stream of bulk material instead of forcing it against the opposite wall. A similar effect can be achieved if the water nozzles of one plane are evenly distributed over the circumference of the downpipe. With an even number of water nozzles, this automatically has the result that two water nozzles respectively lie opposite one another. If, however, three water nozzles are provided on one plane, for example, they are offset in relation to one another by 120°. In some embodiments, the water nozzles of one plane are neither evenly distributed nor lie opposite one another.

The water nozzles used for humidifying are preferably flat-jet nozzles. A flat jet is understood as meaning a jet which is spread out in a dimension transversely in relation to the direction of movement. A flat jet on the one hand penetrates well into the stream of bulk material, but on the other hand is stretched out such that the entire stream of bulk material is humidified. The flat-jet nozzles may be differently aligned. The flat jet may extend parallel to the stream of bulk material, transversely to the stream of bulk material or obliquely to the stream of bulk material. The flat-jet nozzles of one plane may all have the same alignment. It is also possible for the flat-jet nozzles of one plane to differ in their alignment. For example, the flat-jet nozzles of one plane may be aligned alternately parallel and transverse to the stream of bulk material.

It may be sufficient if the water nozzles are arranged on two planes. Better effectiveness is achieved in many cases if the water nozzles are arranged on more than two planes. All the planes may be used for humidifying. It is also possible for the water nozzles of one or more planes to be designed only for cleaning and not for humidifying. The water nozzles may be arranged such that each water nozzle is offset at an angle to all the other water nozzles. It is also possible for the water nozzles of one plane to be only offset at an angle to the water nozzles of a neighboring plane, while water nozzles in the same angular position can be found again in planes further away. In a preferred embodiment, the first two planes, seen in the direction of movement of the bulk material, have an identical number of water nozzles, while a subsequent plane has a greater number of water nozzles. Considering the water nozzles of all the planes in total, the greatest angular distance between two adjacent water nozzles is preferably not greater than 30°, more preferably not greater than 20°, more preferably not greater than 10°.

It is found that it may be conducive to effective humidification if the water from the water nozzles does not impinge on the stream of bulk material in a radial direction but at an angle of less than 90°. Preferably, for this purpose the axis of the water nozzle is inclined downwardly, that is to say in the direction of movement of the stream of bulk material. The direction of movement of the water then has a component parallel to the stream of bulk material. The angle of inclination with respect to the radial direction may be, for example, between 5° and 30°, preferably between 10° and 20°. In some embodiments, the axes of the water nozzles are aligned perpendicular to the axis of the downpipe or are inclined counter to the direction of movement of the stream of bulk material. Preferably, all the water nozzles of one plane have the same angle of inclination.

As an alternative or in addition, the axes of the water nozzles may also be inclined to the side with respect to the radial direction. The direction of movement of the water then has a tangential component with respect to the stream of bulk material. Particularly good intermixing and humidification of the bulk material can be achieved if the water nozzles on a first plane are inclined in the same direction with respect to the radial direction and if the water nozzles on a second plane are inclined in the other direction with respect to the radial direction. A device with water nozzles arranged in this way does not require the water nozzles of the planes being offset at an angle to one another.

The water is intended to emerge from the individual water nozzles of a plane in the form of water jets that are as uniform as possible. For this reason, the water nozzles preferably have an identical geometry. Furthermore, there should be the same water pressure at the water nozzles, which can be achieved for example by the water nozzles being supplied from a common water connection. In an advantageous embodiment, an annular pipe enclosing the downpipe is provided, supplying the water nozzles with water. An annular pipe for supplying the water nozzles of a number of planes may be provided. It is likewise possible for an annular pipe to supply the water nozzles of only one plane, and for an annular pipe to be provided for each plane. This is advantageous particularly whenever the water nozzles of one plane are intended to be used only for cleaning and not for humidifying, and it is therefore intended to feed water to the planes independently from one another.

The water jet emerging from the water nozzles is intended to be dimensioned such that it penetrates into the center of the stream of bulk material and at the same time brings about good intermixing of the stream of bulk material. The exact appearance of the water jet depends on the properties of the bulk material. For a bulk material of a loose composition and low density, a water jet of lower hardness, which can moreover be fanned out to cover a larger surface area, may be sufficient. For a bulk material of higher density, a concentrated water jet of greater hardness may be required. To be able to adapt the properties of the water jet correspondingly, it may be provided that the water nozzles are displaceable in relation to an outlet opening through which the water is directed onto the stream of bulk material. If the water nozzle is withdrawn further from the outlet opening, a concentrated water jet is created. If the water nozzle is pushed closer to the outlet opening, the water jet fans further out. The outlet opening is preferably arranged in the wall of the downpipe. The outlet opening and the water nozzle should not protrude into the downpipe in order not to hinder the stream of bulk material.

The bulk material preferably enters the downpipe in a fluidized form. A bulk material may be fluidized by gas being introduced into the bulk material from below, so that the bulk material becomes similar to a liquid in its properties. The inlet of the downpipe may be adjoined by a feed line, in which the bulk material is brought into a fluidized state or is kept in the fluidized state. In an advantageous embodiment, a storage tank for the bulk material, in which the bulk material is contained in the fluidized state, is arranged above the downpipe. The fluidized bulk material may enter the downpipe from the storage tank under the influence of gravitational force. Also included are embodiments in which the bulk material enters the downpipe in a non-fluidized state.

The downpipe may be made up of a number of modules, one module preferably being provided for each plane of water nozzles. The modules with the water nozzles may be identically constructed and, in particular, have an identical arrangement of the water nozzles. Turning the modules in relation to one another may achieve the effect that the water nozzles are offset at an angle to one another.

A method for humidifying a bulk material is also disclosed. Deposits which form in a downpipe during the humidifying of a bulk material have previously been removed by mechanical means. For this purpose, a stripper may be provided in the downpipe, for example, as in DE4127447, or the downpipe must even be opened in order that the deposits can be removed manually.

A bulk material is fed to a downpipe. The stream of bulk material in the downpipe is humidified by a plurality of water nozzles. To clean the downpipe, the stream of bulk material is interrupted. The downpipe is freed of deposits of the bulk material by water which is fed to the downpipe through water nozzles. In one embodiment of the method, the same water nozzles are used for removing the deposits as for humidifying the stream of bulk material. Tests have shown that a good cleaning effect can be achieved in this way if the deposits are not too firmly attached. This was unexpected, because the water jet then impinges on the deposits from the same direction as that in which the deposits have built up.

In the case of another embodiment of the method, the water for removing the deposits emerges from different water nozzles than the water with which the stream of bulk material is humidified. The water then impinges on the deposits at a different angle, particularly at an acute angle, and the deposits can thereby be lifted off from the wall of the downpipe with greater effectiveness. The water nozzles concerned may be arranged above or below the nozzles through which the bulk material is humidified.

The method may be carried out with fresh water. The use of waste waters of different types is also possible. The water used may contain a proportion of up to 30% solids. Contaminated water may be used for humidifying the bulk material, while fresh water is used for the cleaning. The pressure with which the water is fed to the water nozzles should be at least 0.5 bar. Preferably, the water pressure lies between 3 bar and 6 bar. The method may be carried out with cold water or warm water. If the bulk material is fly ash, up to 400 t/h can be treated, it being possible to feed 30% water to the bulk material. The device is designed for the purpose of carrying out the method.

### BRIEF DESCRIPTION OF THE DRAWINGS

The invention is described below by way of example on the basis of an advantageous embodiment with reference to the accompanying drawings, in which:

FIG. 1 shows a schematic representation of a device;

FIG. 2 shows a schematic representation of the arrangement of water nozzles from FIG. 1 on three different planes;

FIGS. 3 and 4 show the view from FIG. 2 in the case of other embodiments of the invention;

FIG. 5 shows a schematic representation of an alternative form of a downpipe;

FIG. 6 shows an enlarged representation of a water nozzle;

FIG. 7 shows the view from FIG. 6 with a different position of the water nozzle;

FIG. 8 shows a schematic representation of the arrangement of water nozzles in the case of another embodiment; and

FIG. 9 shows an alternative embodiment of a device.

### DETAILED DESCRIPTION

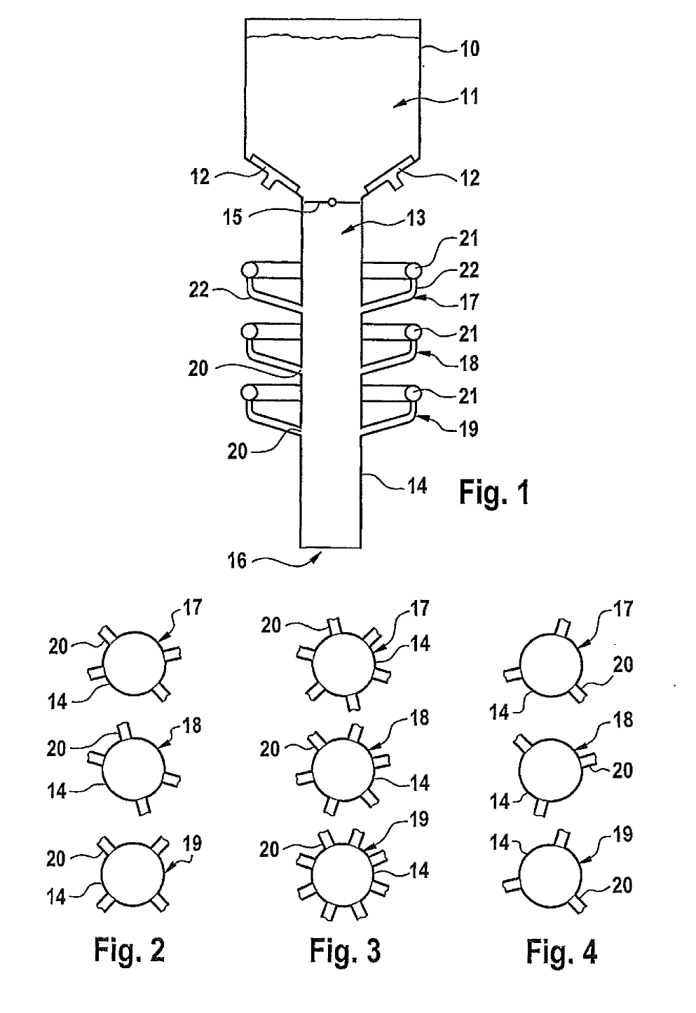

A device shown in FIG. 1 comprises a storage tank 10, which is filled with a bulk material 11. The bulk material is ash, which is created during the operation of a power plant. Arranged at the lower end of the storage tank 10 are fluidizing elements 12. Air can be directed through the fluidizing elements 12 into the bulk material 11, so that the bulk material 11 is transformed into a fluidized state.

The storage tank 10 goes over with its lower end into a vertically arranged downpipe 14. The outlet of the storage tank 10 at the same time forms the inlet 13 of the downpipe 14. Formed at the transition from the storage tank 10 to the downpipe 14 is a closure 15, which in FIG. 1 is represented in the closed state. In the closed state, the closure 15 prevents bulk material 11 from being able to leave the storage tank 10; the closure 15 therefore closes off the storage tank 10 in the downward direction. If the closure 15 is opened, the bulk material 11 can enter the downpipe 14 in a fluidized state. From the region of the inlet 13, the bulk material falls downward, until it leaves from the downpipe 14 through an outlet 16.

Arranged in the wall of the downpipe 14 on a first plane 17, a second plane 18 and a third plane 19 are water nozzles 20, which in FIG. 1 are only schematically represented as openings in the wall of the downpipe 14. According to FIG. 6, extending outwardly from the wall of the downpipe 14 is a sleeve 27, which opens out in the wall of the downpipe 14 as an outlet opening 28. Arranged in the sleeve 27 is the actual water nozzle 20, from which a water jet 29 emerges in FIG. 6. The water nozzles 20 are aligned in the radial direction with the center of the downpipe 14, but inclined slightly downwardly with respect to the horizontal. As the sectional representations through the plane 17, the plane 18 and the plane 19 in FIG. 2 show, the water nozzles 20 of the planes 17, 18, 19 are offset at an angle to one another, and so the radii formed from the water nozzles 20 to the axis of the downpipe have different directions in each case.

Provided for each of the planes 17, 18, 19 is an annular pipe 21, which surrounds the downpipe 14. From the water nozzles 20 there respectively extend connecting lines 22 to the associated annular pipe 21. Water which is under pressure is fed to the annular pipe 21 through a feed line that is not represented. The water passes via the annular pipes 21 and the connecting lines 22 to the water nozzles 20 and from there enters the downpipe 14, where it impinges on the stream of bulk material falling through the downpipe 15. The water penetrates into the stream of bulk material and at the same time mixes the stream of bulk material. Impingement of the water on the stream of bulk material from different directions on the planes 17, 18, 19 ensures that the bulk material is humidified completely before it leaves through the outlet 16 of the downpipe 14.

The water which is fed to the water nozzles 20 may be a waste water, in a power plant for example the waste water of a flue gas desulphurization plant. If deposits are formed during the humidification of the stream of bulk material, the stream of bulk material is interrupted to remove the deposits again. For cleaning, water is fed once again to the water nozzles 20, that is to say the same nozzles with which the bulk material was also humidified. The water emerges from the water nozzles 20 and impinges on the deposits. If the deposits have not yet become too firmly lodged, they are dislodged under the influence of the water jet. Fresh water may be used for the cleaning.

In the case of the embodiment shown in FIG. 2, four water nozzles 20 are formed on the plane 17, two water nozzles 20 respectively lying opposite one another in pairs. On the plane 17, the water nozzles 20 are not evenly distributed, but the connecting lines between two opposing water nozzles 20 between them form an angle of less than 90°. On the plane 18 lying therebelow, four water nozzles 20 are likewise formed in a comparable arrangement, arranged offset at an angle to the water nozzles 20 of the plane 17. On the lowermost plane 19 there are in turn four water nozzles 20, which however, unlike on the planes 17, 18, are evenly distributed over the circumference of the downpipe 14. The water nozzles 20 of the plane 19, are offset at an angle both to the water nozzles 20 of the plane 17 and to the water nozzles 20 of the plane 18.

In the case of the embodiment of FIG. 3, six water nozzles 20, which are evenly distributed over the circumference of the downpipe 14, are respectively formed on the planes 17, 18. On the plane 19 there are eight water nozzles 20, evenly distributed over the circumference of the downpipe 14. The water nozzles 20 of all the planes 17, 18, 19 are offset at an angle to one another.

In FIG. 4, the downpipe 14 on each of the planes 17, 18, 19 comprises three water nozzles 20. The water nozzles 20 are evenly distributed over the circumference of the downpipe 14, but they do not lie opposite one another in pairs because of the uneven number of water nozzles 20. The water nozzles 20 of the plane 17 are offset at an angle to the water nozzles 20 of the plane 18, but not offset at an angle to the water nozzles 20 of the plane 19.

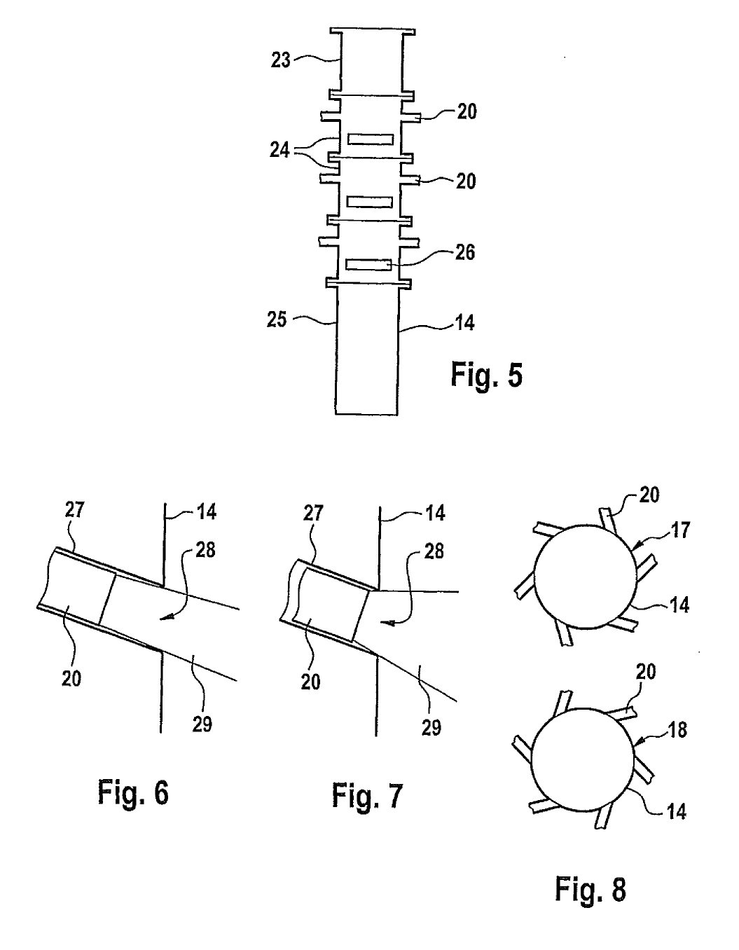

In the case of the embodiment shown in FIG. 5, the downpipe 14 is made up of a plurality of modules. The inlet 13 of the downpipe is formed by a module 23, the outlet 16 by a module 25. Arranged between the modules 23 and 25 are three modules 24, which respectively comprise water nozzles 20 arranged in one plane. The water nozzles 20 are perpendicular in the wall of the downpipe 14 and are aligned radially with the center of the downpipe 14. The modules 24 are structurally the same as one another in each case; the different angular position of the water nozzles 20 is achieved by the modules 24 being turned with respect to one another at their connecting flanges. Formed on each of the modules 24 is an opening which is closed by a cover 26 and makes access to the interior of the downpipe 14 possible for the purpose of cleaning. At the joints, the modules 23, 24, 25 terminate flush with one another, so that the inner wall of the downpipe 14 is smooth. The inner wall of the downpipe 14 is enameled. The water nozzles 20 do not protrude into the downpipe 14.

According to FIGS. 6 and 7, the water nozzle 20 can be displaced in the sleeve 27. In FIG. 6, the water nozzle 20 is shown in a withdrawn position, in which it is at a greater distance from the outlet opening 28. The withdrawn position leads to a more concentrated water jet 29. If, as shown in FIG. 7, the water nozzle 20 is in a forward position, closer to the outlet opening 28, the water jet 29 is again fanned out. Even in its forward position, the water nozzle 20 does not protrude into the interior space of the downpipe 14. By suitable positioning of the water nozzle 20 in the sleeve 27, the water jet 29 can be set such that the stream of bulk material is reliably humidified.

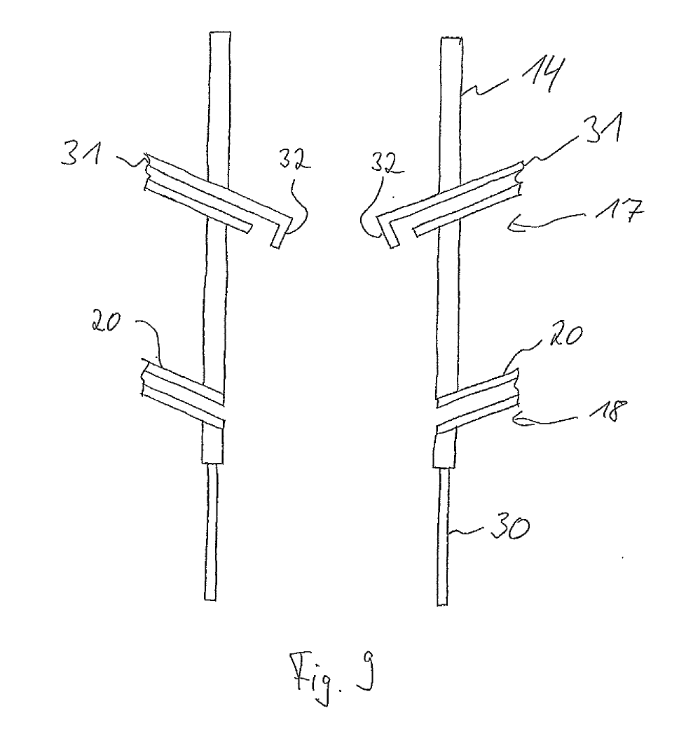

Shown in FIG. 8 is an embodiment of a device in which the water nozzles 20 are arranged on merely two planes 17, 18. The water nozzles 20 are inclined to the side with respect to the radial direction. The water nozzles 20 on the upper plane 17 are inclined to the left with respect to the radial direction, the water nozzles 20 on the lower plane 18 are inclined to the right with respect to the radial direction. On both planes 17, 18, the water emerging from the water nozzles 20 thereby has a tangential component in relation to the stream of bulk material. The opposed setting of the tangential components in relation to one another on the planes 17, 18 achieves effective intermixing and humidifying of the stream of bulk material.

An alternative embodiment that is shown in FIG. 9 likewise has two planes 17, 18 of water nozzles, eight water nozzles being provided on each plane 17, 18. The water nozzles 20 of the plane 18 (humidifying plane) are flat-jet nozzles. The water with which the stream of bulk material is humidified in the downpipe 14 is fed through the water nozzles 20. The water nozzles 20 of the humidifying plane are sufficient to humidify the bulk material in the downpipe 14 completely. The downpipe 14 ends several centimeters below the water nozzles 20. The downpipe 14 is adjoined in the downward direction by a tube 30 with a flexible wall. The flexible wall of the tube 30 is set in motion by the stream of bulk material. The motion contributes to the water being uniformly mixed with the bulk material. Furthermore, no bulk material can become deposited on the wall of the tube 20 as long as the wall is in motion.

However, deposits are to be expected in the region between the water nozzles 20 and the lower end of the downpipe 14 and also possibly somewhat above the water nozzles 20. The plane 17 is arranged some distance above the humidifying plane, where there are no longer any deposits of the bulk material. The water nozzles 31 of this plane (cleaning plane) do not serve the purpose of humidifying the bulk material but of removing the deposits that have formed further below. The water nozzles 31 protrude into the interior of the downpipe 14. This is not detrimental because the water nozzles 31 lie outside the region in which deposits form.

The water nozzles 31 are formed as what are known as fan nozzles, that is to say a diverting area 32 on which the water jet impinges and is deflected downwardly in the form of a flat jet is arranged in the extension of the nozzle axis. The flat jet impinges on the inner wall of the downpipe 14 at an acute angle and lifts off the deposits from the wall. The water nozzles 31 of the cleaning plane are not in operation as long as the stream of bulk material is being humidified from the water nozzles 20 of the humidifying plane. The water nozzles 31 of the cleaning plane are only put into operation when deposits have formed, and the stream of bulk material has been interrupted for the removal of the deposits.

1. A device for humidifying a bulk material comprising a downpipe at the upper end of which there is formed an inlet, through which the bulk material enters the downpipe, and at the lower end of which there is formed an outlet, through which the bulk material leaves in a humidified state, characterized in that a plurality of water nozzles are arranged on a first plane in the downpipe and in that a plurality of water nozzles are arranged on a second plane in the downpipe, the water nozzles of the first plane being arranged offset at an angle to the water nozzles of the second plane.

2. The device as claimed in claim 1, characterized in that water feeds are provided for the water nozzles of the first plane and of the second plane, the water feeds being independent from one another.

3. The device as claimed in claim 1, characterized in that the water nozzles do not protrude into the downpipe.

4. The device as claimed in claim 1, characterized in that the water nozzles of a first plane protrude into the downpipe and in that the water nozzles of a second plane do not protrude into the downpipe.

5. The device as claimed in claim 1, characterized in that the lower end of the downpipe is adjoined by a tube with a flexible wall.

6. The device as claimed in claim 1, characterized in that the distance between the lower end of the downpipe and the second plane of water nozzles is spaced a distance less than 50 cm.

7. The device as claimed in claim 1, characterized in that water nozzles are inclined downwardly with respect to a radial direction.

8. The device as claimed in claim 1, characterized in that water nozzles are inclined to a side with respect to a radial direction.

9. The device as claimed in claim 8, characterized in that the water nozzles on the first plane are inclined to one side and in that the water nozzles on the second plane are inclined to another side.

10. The device as claimed in claim 1, characterized in that an annular pipe enclosing the downpipe is provided for supplying the water nozzles with water.

11. The device as claimed in claim 1, characterized in that a storage tank for the bulk material is connected to the inlet of the downpipe and in that means for fluidizing the bulk material are formed on the storage tank.

12. The device as claimed in claim 1, characterized in that the downpipe comprises a plurality of modules, in which water nozzles are formed, and in that the modules are structurally the same as one another.

13. A method for humidifying a bulk material, comprising the following steps:
a. feeding a bulk material to a downpipe having a wall;
b. feeding water to a plurality of water nozzles arranged in the wall of the downpipe, so that the water enters the downpipe from the water nozzles and humidifies the stream of bulk material;
c. interrupting the stream of bulk material; and
d. feeding water to a plurality of water nozzles arranged in the wall of the downpipe, so that the water enters the downpipe through the water nozzles and removes deposits of the bulk material from the wall of the downpipe.

14. The method as claimed in claim 13, characterized in that the water is fed to the same water nozzles in step d. as in step b.

15. The method as claimed in claim 13, characterized in that the water is fed to different water nozzles in step d. than in step b.

16. The device as claimed in claim 2, characterized in that the water nozzles do not protrude into the downpipe.

17. The device as claimed in claim 2, characterized in that the water nozzles of a first plane protrude into the downpipe and in that the water nozzles of a second plane do not protrude into the downpipe.

18. The device as claimed in claim 1, characterized in that the lower end of the downpipe is adjoined by a tube with a flexible wall.

19. The device as claimed in claim 6 wherein the distance is less than 20 cm.

20. The device as claimed in claim 6 wherein the distance is less than 10 cm.
